(19) United States
(12) Patent Application Publication
(10) Pub. No.: US 2026/0220511 A1
(43) Pub. Date: Jul. 30, 2026

(54) QUANTUM COMPUTER

(71) Applicant: Hitachi, Ltd., Tokyo (JP)

(72) Inventors: Tatsuya TOMARU, Tokyo (JP); Hiroyuki MIZUNO, Tokyo (JP); Naoto SATO, Tokyo (JP)

(21) Appl. No.: 19/144,982

(22) PCT Filed: Feb. 14, 2023
(86) PCT No.: PCT/JP2023/004954

§ 371 Date: Jul. 1, 2025

(51) Int. Cl. G06N 10/40

(52) U.S. Cl. CPC G06N 10/40

(57) ABSTRACT

Measurement becomes possible by causing qubits to cycle within the array such that syndrome qubits periodically appear at a measurement location. In addition, a vacant quantum dot is provided between a data qubit and a syndrome qubit, whereby qubits can move inside the array, and interaction between adjacent data qubits and syndrome qubits becomes possible. As a result, syndrome measurement periodically becomes possible even in an array in which measurement locations are limited, and implementation of quantum error correction becomes possible even in a highly integrated qubit array. In addition, the same operation aligns in the column direction or the row direction, and an intended operation becomes possible even with shared wiring.

### TECHNICAL FIELD

The present invention pertains to a quantum computer.

### BACKGROUND ART

Progress in quantum computer technology in recent years has been dramatic. In conjunction therewith, expectations towards realizing a practical quantum computer are increasing. Accordingly, integration and quantum error correction are necessary.

From a perspective of high integration, it would be advantageous to configure qubits based on Si, which would allow LSI technology to be utilized. Patent Document 1 and Non-Patent Document 1 disclose a highly integrated Si quantum dot array for arranging qubits with use of LSI techniques. This allows the number of qubits itself to be highly integrated, but assigning a control signal line for each quantum dot is spatially difficult, and sharing signal lines has been planned. This leads control to be in units of rows or units of columns of the array, making individually controlling qubits difficult. As a countermeasure, there has been proposed a method of realizing a gate operation by preparing, inside an array, a region for performing a gate operation on individual qubits (a single-qubit gate) or a region for causing interaction between two qubits (a two-qubit gate), and moving (shuttling) the qubits needing these gate operations to the region (Non-Patent Document 2). In a highly integrated array, in addition to the difficulty of control, measuring individual qubits also becomes difficult. In Non-Patent Document 1, one of the four edges (ends) of an array is allocated to a measurement location.

High-density integration is accompanied by constraints, as described above. Meanwhile, there are also requests for quantum error correction, which is another necessary element. Let us take surface codes, which are currently seen as most promising in quantum error correction, as an example (Non-Patent Document 3). In a surface code, qubits inside an array are classified into two types—data qubits for holding quantum information, and syndrome qubits for detecting errors in data qubits—and these are arranged in an alternating manner. It is necessary for adjacent data qubits and syndrome qubits to interact, and it is also necessary to measure all data qubits. These interaction and measurement requirements clearly do not reconcile with the constraints that accompany high integration.

### PRIOR ART DOCUMENT

### Patent Document

Patent Document 1: WO 2021/024533 A 1

### Non-Patent Documents

Non-Patent Document 1: N. Lee et al. Applied Physics Letters 116, 162106(2020).

Non-Patent Document 2: J. M. Boter et al., Phys. Rev. Appl. 18, 024053(2022).

Non-Patent Document 3: A. G. Fowler et al., Phys. Rev. A 86, 032324(2012).

### SUMMARY OF THE INVENTION

### Problems to be Solved by the Invention

In a highly integrated qubit array, regions in which a gate operation is possible are limited, and locations where measurement is possible are also limited. Meanwhile, in order to realize quantum error correction, allowing interaction between any adjacent qubits is necessary, and at least measurement of syndrome qubits is necessary. Reconciling both of these requests is a problem to be addressed.

### Means for Solving the Problems

One aspect of the present invention is a quantum computer including a quantum operation unit, in which the quantum operation unit includes a quantum dot array for arranging qubits, a gate unit for performing a gate operation on the qubits, and a measurement unit for measuring the qubits, the qubits are classified into data qubits for holding information and syndrome qubits for performing measurement, the data qubits and the syndrome qubits are arranged in the quantum dot array in an alternating manner, a vacant quantum dot is arranged between a data qubit and a syndrome qubit in the arrangement, the qubits arranged in the quantum dot array are caused to cycle in a row direction or a column direction of the quantum dot array, and measurement is performed when the syndrome qubit has reached a location inside the quantum dot array at which measurement with the measurement unit is possible.

### Advantages of the Invention

In a highly integrated qubit array in which regions in which a gate operation is possible are limited and locations at which measurement is possible are also limited, interaction between any adjacent qubits that are needed in order to realize quantum error correction becomes possible, and measurement of at least a syndrome qubit becomes possible.

### BRIEF DESCRIPTION OF THE DRAWINGS

FIG. 1 is a conceptual diagram that illustrates an example of a two-dimensional qubit array in which a surface code is implemented.

FIG. 2a is a circuit diagram of stabilizer measurement for error detection.

FIG. 2b is a circuit diagram of stabilizer measurement for error detection.

FIG. 3 is a conceptual diagram for describing a principle for implementing a surface code on a qubit array that is cycled.

FIG. 4a is a conceptual diagram that illustrates a qubit pair for which a CNOT is performed and qubits for which measurement is performed, at a certain point in time pertaining to stabilizer measurement in a qubit array that is cycled.

FIG. 4b is a conceptual diagram that illustrates a qubit pair for which a CNOT is performed and qubits for which measurement is performed, at a different point in time pertaining to stabilizer measurement in a qubit array that is cycled.

FIG. 4c is a conceptual diagram that illustrates a qubit pair for which a CNOT is performed and qubits for which measurement is performed, at a different point in time pertaining to stabilizer measurement in a qubit array that is cycled.

FIG. 4d is a conceptual diagram that illustrates a qubit pair for which a CNOT is performed and qubits for which measurement is performed, at a different point in time pertaining to stabilizer measurement in a qubit array that is cycled.

FIG. 4e is a conceptual diagram that illustrates a qubit pair for which a CNOT is performed and qubits for which measurement is performed, at a different point in time pertaining to stabilizer measurement in a qubit array that is cycled.

FIG. 5a is a conceptual diagram for giving a description regarding necessary movement of qubits when operating a surface code in a qubit array that is cycled.

FIG. 5b is a conceptual diagram that summarizes FIG. 5a from a different perspective.

FIG. 6 is a circuit diagram that illustrates a CNOT and an equivalent circuit.

FIG. 7 is a conceptual diagram that illustrates a qubit array for which there is a qubit measurement unit at the left end thereof in addition to the right end thereof.

FIG. 8 is a conceptual diagram that illustrates a qubit array that is also provided with a qubit measurement unit inside in addition to the left and right ends thereof.

FIG. 9 is a conceptual diagram of a qubit array that is provided with a qubit injection unit at the left end thereof.

FIG. 10 is a conceptual diagram that illustrates an example of a qubit array resulting from increasing the number of quantum dots for which qubits are vacant, in comparison to FIG. 3 through FIG. 9.

FIG. 11a is a conceptual diagram that illustrates a Z_{L} operator and an X_{L} operator in a surface code.

FIG. 11b is a conceptual diagram that illustrates a Z_{L} operator and an X_{L} operator in a surface code implemented in a qubit array that is cycled.

FIG. 12a is a conceptual diagram that illustrates a Z_{L} operator and an X_{L} operator that are defined using an X-cut defect pair.

FIG. 12b is a conceptual diagram that illustrates a Z_{L} operator and an X_{L} operator that are defined using an X-cut defect pair in a qubit array that is cycled.

FIG. 13a is a conceptual diagram that illustrates a Z_{L} operator and an X_{L} operator that are defined using a Z-cut defect pair.

FIG. 13b is a conceptual diagram that illustrates a Z_{L} operator and an X_{L} operator that are defined using a Z-cut defect pair in a qubit array that is cycled.

FIG. 14a is a conceptual diagram indicating that an X_{L} operator in a surface code can be geometrically deformed.

FIG. 14b is a conceptual diagram indicating that an X_{L} operator in a surface code which is implemented in a qubit array that is cycled can be geometrically deformed.

FIG. 15a is a conceptual diagram indicating that a Z_{L} operator for a logical qubit is defined merely by one data qubit, owing to an X-cut defect pair to be adjacent.

FIG. 15b is a conceptual diagram indicating that a Z_{L} operator for a logical qubit is defined merely by one data qubit, owing to an X-cut defect pair to be adjacent in a qubit array that is cycled.

FIG. 16 is a block diagram that illustrates a configuration of the entirety of a computer that incorporates a quantum operation apparatus for implementing the present embodiment.

FIG. 17 is a flow chart that illustrates an example of software for realizing the present embodiment.

### MODES FOR CARRYING OUT THE INVENTION

Using the drawings, description is given in detail regarding embodiments. However, the present invention is not to be interpreted by being limited to the content set forth in the embodiments described below. It will easily be understood by those skilled in the art that the specific configurations can be changed without departing from the concept or gist of the present invention.

In configurations of embodiments described below, the same reference symbols are used across different drawings for the same portions or portions having similar functionality, and there are cases where duplicative description is omitted.

In the case where there is a plurality of elements having the same or: similar functionality, there are cases where different suffixes are added to the same reference symbol for their description. However, in the case where there is no need to distinguish between the plurality of components, description without the suffix may be given.

Such writing as “first,” “second,” and “third” in the present specification or the like is added in order to identify components, and there is not necessarily a limitation to the number, the order, or the content thereof. In addition, numbers for identifying components are used in each context, and there is no limitation to the number used in one context necessarily indicating the same configuration in another context. In addition, a component identified by a certain number is not obstructed from also having functionality of a component identified by another number.

In order to facilitate understanding of the invention, there are cases where the position, size, shape, range, etc., of configurations illustrated in the drawings or the like do not represent actual positions, sizes, shapes, ranges, etc. Accordingly, the present invention is not necessarily limited to the positions, sizes, shapes, ranges, etc., disclosed in the drawings.

Publications, patents, and patent applications cited in the present specification directly form a portion of the description of the present specification.

A component represented in the singular in the present specification is assumed to include the plurality thereof, to the extent that there is particularly no clear indication given in the context.

A surface code is given as a quantum error correction method that is viewed as promising at present.

In addition, a surface code is a representative code in the wide concept referred to as a topological code.

Accordingly, the present embodiment describes how to make quantum error correction operate on a qubit array, by choosing a surface code as an example. However, the methodology described in the present embodiment can easily be expanded, even to quantum error correction other than surface codes.

Embodiments of the present invention enable measurement by causing qubits to cycle within an array such that syndrome qubits periodically appear at measurement locations. In addition, a vacant quantum dot is provided between a data qubit and a syndrome qubit, whereby qubits can move inside the array, and interaction between adjacent data qubits and syndrome qubits becomes possible. To describe embodiments of the present invention, description is firstly given for the mechanism of a surface code.

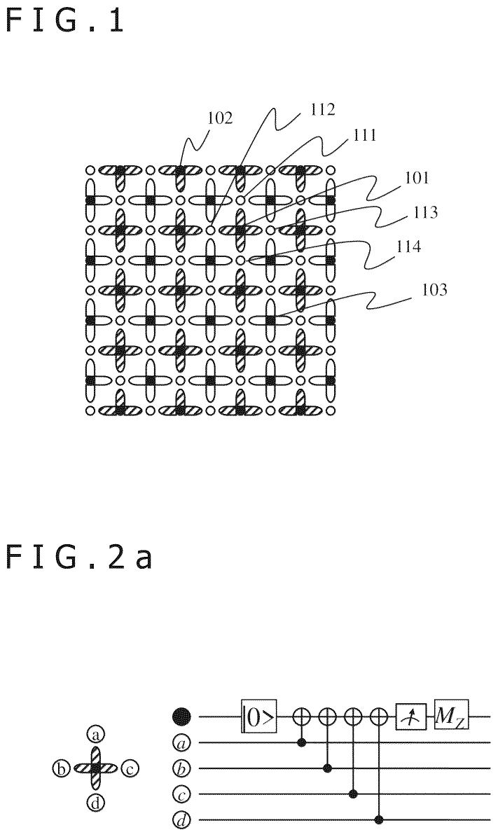

As illustrated in FIG. 1, qubits are arranged at vertexes of a two-dimensional grid in a surface code.

White circles and black circles are qubits. Note that both are colored by role, and the physical substance of the qubits is the same therebetween. The white circles are data qubits that hold quantum information, and the black circles are syndrome qubits for detecting errors in the data qubits. The two are arranged in an alternating manner. The black-circle syndrome qubits are further classified into two types: black-circle qubits surrounded by diagonal-line edges (for example, a syndrome qubit 101), and black-circle qubits surrounded by white-on-black edges (for example, a syndrome qubit 103). The former are responsible for bit-flip error detection, and the latter are responsible for phase-flip error detection.

Description is firstly given for the former.

Each syndrome qubit is surrounded by four nearest-neighbor data qubits. For example, the syndrome qubit 101 in FIG. 1 is surrounded by data qubits 111, 112, 113, and 114, and is responsible for detecting a bit-flip error thereof. However, as with reference number 102, for example, a syndrome qubit positioned at an end is responsible for three data qubits. An “end” in FIG. 1 refers to a position where the number of nearest-neighbor qubits is less than four.

In order to detect errors, it is necessary to transfer information belonging to a data qubit into a syndrome qubit. Interaction is necessary for the transfer, and a diagonal-line edge joining the qubits 101 and 111, for example, means interaction to be caused. This interaction is a gate operation referred to as a CNOT. In addition to the qubits 101 and 111, a CNOT is also performed on the qubits 101 and 112, 101 and 113, and 101 and 114.

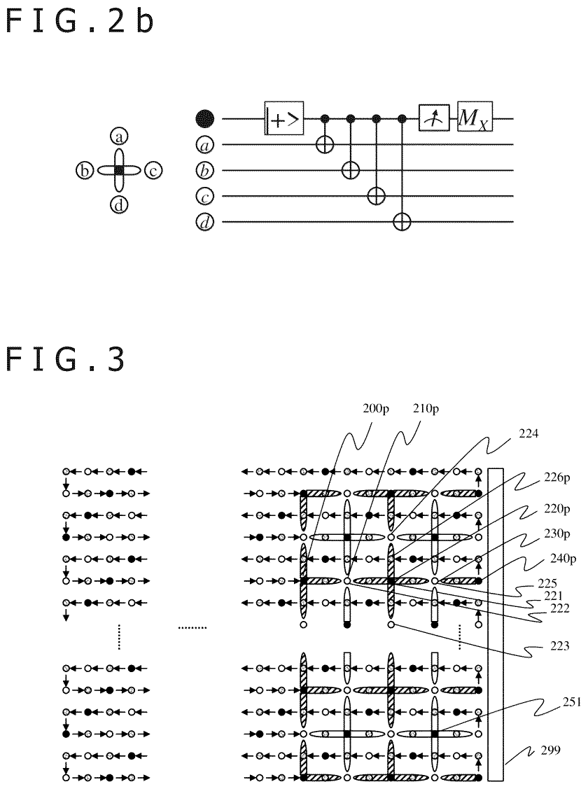

FIG. 2a illustrates a portion of these four CNOT gates with a circuit diagram. A black circle corresponds to the qubit 101, and a, b, c, and d respectively correspond to the qubits 111, 112, 113, and 114. The black-circle syndrome qubit is initialized to |0>, subsequently, a CNOT operation with a data qubit is performed sequentially (the data qubit is the control, and the syndrome qubit is the target), and finally, measurement (Z-basis measurement) that employs |0> and |1> as bases is performed. Letting the Z operator on a qubit i (i=a, b, c, d) be Zᵢ, the quantity measured with the circuit in FIG. 2a becomes ZₐZ_{b}Z_{c}Z_{d}.

The principles of an operation by a syndrome qubit that is responsible for phase-flip error detection (reference number 103 in FIG. 1, for example) are similar, but there are changes in comparison to the case of detecting a bit-flip error (FIG. 2a).

FIG. 2b illustrates a circuit diagram for phase-flip error detection. The initial state of the syndrome qubit (black circle) is |+>=(|0>+|1>)/√2, and the measurement basis becomes |+> and |−>=(|0>−|1>)/√2 (X-basis measurement). In addition, the control and the target in the CNOT become the reverse of that in FIG. 2a. Apart from these changes, bit-flip error detection and phase-flip error detection may be similar operations. Letting the X operator on a qubit i (i=a, b, c, d) be Xᵢ, the quantity measured in the circuit in FIG. 2b becomes XₐX_{b}X_{c}X_{d}.

A gate unit for performing a gate operation on a qubit can be realized by a configuration that includes a gate electrode to which a semiconductor manufacturing technique has been applied, as described in Patent Document 1, for example. A gate operation that uses a gate unit is itself publicly known, and thus description thereof is omitted.

The operations in FIG. 2a and FIG. 2b are simultaneously executed with respect to all of the syndrome qubits in FIG. 1. However, it may be that operations with respect to one or more syndrome qubits are stopped, as described below. Measurements based on the circuits in FIG. 2a and FIG. 2b are commutative in relation to all syndrome qubits, and these measurements may be referred to as stabilizer measurement. Accordingly, stabilizer measurement, syndrome measurement, and error detection measurement are synonymous.

As described above, each syndrome qubit is responsible for four data qubits. Conversely, an error in a data qubit is detected through four syndrome qubits. As seen in FIG. 1, two of these are performed through diagonal-line edges, and the remaining two are performed through white-on-black edges. In other words, each data qubit is defended by two syndrome qubits that are responsible for bit-flip error detection and two syndrome qubits that are responsible for phase-flip error detection. As can be inferred from this mechanism, an error in each data qubit is not determined using a measurement result from one syndrome qubit, and comprehensively determined using all measurement results (Non-Patent Document 3). One reason why stabilizer measurement and a later-described logical qubit are commutative is based on this mechanism.

The principle of error detection in a surface code is as above.

### First Embodiment

FIG. 3 is a conceptual diagram for describing principles of a first embodiment. As described above, it is necessary to measure all syndrome qubits in a surface code. However, wiring in a highly integrated qubit array is dense, and measurement of qubits inside the array becomes difficult. It is often the case that only an end of the array can be measured. Accordingly, as illustrated in FIG. 3, all qubits are caused to cycle and, having arrived at an end of the array, are measured by a measurement unit that includes a measurement circuit 299. A white circle represents a data qubit, and a black circle represents a syndrome qubit. Circles having a dot pattern represent the positions of quantum dots for which qubits are absent. Note that an operation for causing a qubit to move (shuttle) is disclosed in Non-Patent Document 2 or the like, and thus description thereof is not repeated here.

In the present embodiment, the qubits are cycled and moved in accordance with a clock, for example. Vacant quantum dots that are arranged between qubits are used in order to reserve a temporary destination for the movement. In addition, in a case of performing a CNOT operation (interaction) between qubits that are not adjacent to be performed, one qubit is caused to move to a vacant quantum dot to thereby make the qubits adjacent to each other. The vacant quantum dots are arranged for such purposes, and the positional relation between qubits changes in accordance with the clock.

FIG. 3 illustrates a case in which only a right end is measurable by the measurement circuit 299. For example, attention is given to a syndrome qubit at a position 240p. The “p” added to the end of the number represents that the number is assigned to a position. In conjunction with the cycling, the syndrome qubit at the position 240p has reached the present position after going through the positions 200p, 210p, 220p, and 230p. As illustrated in FIGS. 3, 200p, 210p, 220p, and 230p each indicate a position every two quantum-dot moving.

Before measurement with the measurement circuit 299, it is necessary to perform a CNOT operation with the four nearest-neighbor data qubits. Consider the time when the syndrome qubit at the position 240p was at the position 220p. The number of the syndrome qubit is set to 221. The data qubits for which a CNOT operation with 221 is necessary are data qubits 222, 223, 224, and 225. Because all of the qubits are cycled, a CNOT operation is actually performed at each of the positions 200p, 210p, 220p, and 230p.

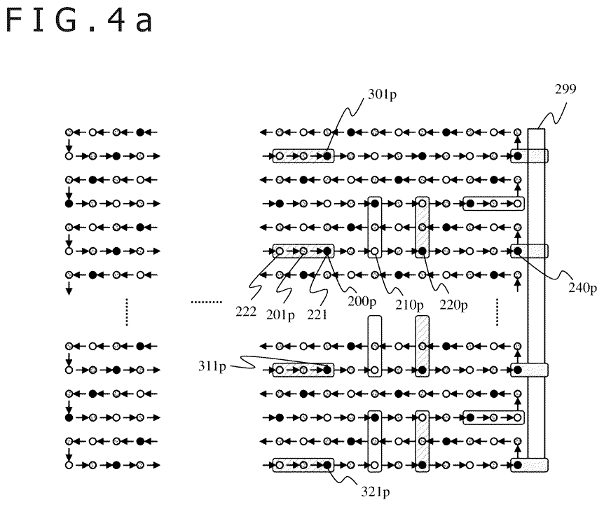

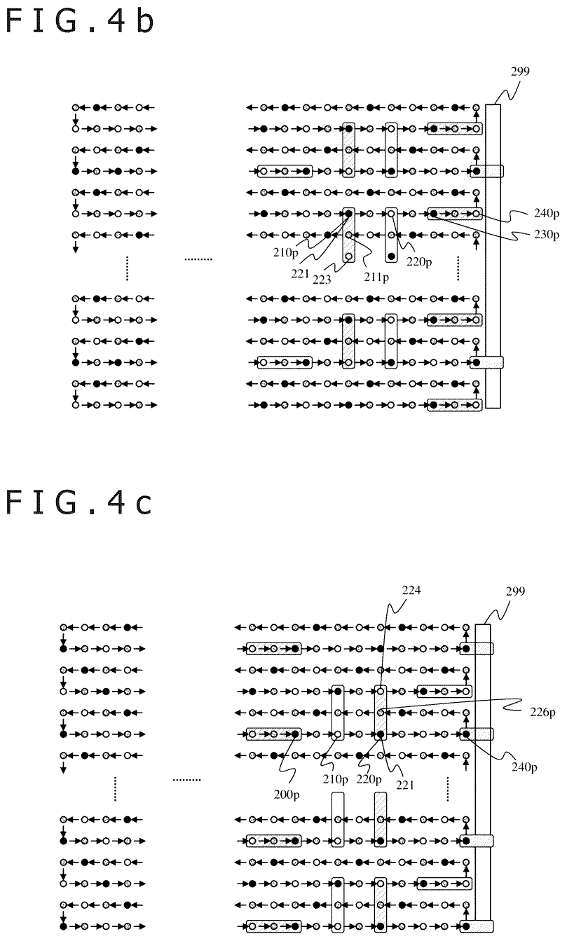

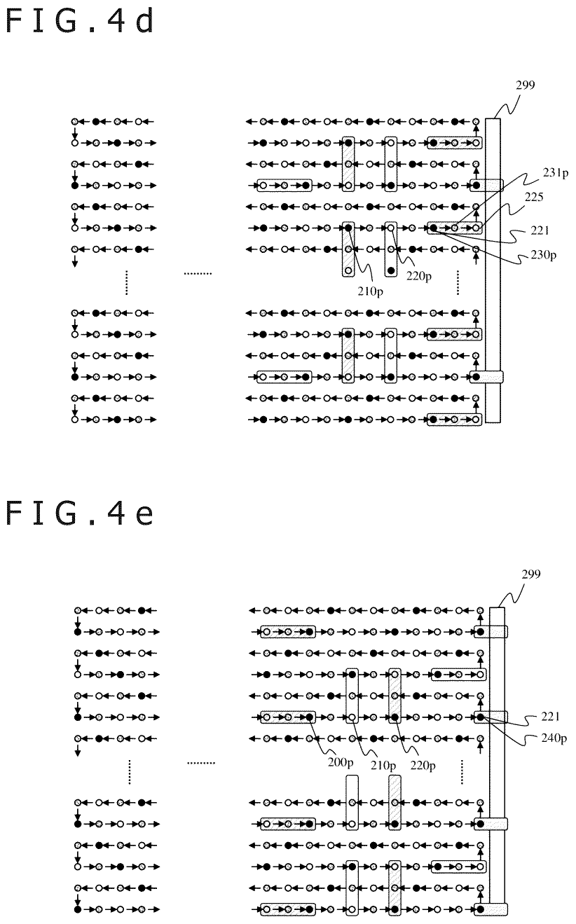

FIG. 4a illustrates a situation for the point in time when the syndrome qubit 221 was at the position 200p. At this point in time, the counterpart for the CNOT operation with 221 is 222. The vacant position 201p is between 221 and 222. 221 and 222 cannot directly interact, but the CNOT operation is realized by causing 221 or 222 to move to the position 201p. After the CNOT operation is performed, the qubit that has been moved is returned to the original position, and all of the qubits are caused to cycle. Description is given regarding the syndrome qubit 221 at the position 200p as an example, but the syndrome qubits at 301p, 311p, and 321p have the same operation as that for the syndrome qubit at 200p. In other words, regions having a common operation are aligned in the column direction.

At this point in time, a CNOT operation is also performed for a rectangular region that surrounds the positions 210p, 220p, and the like. A common-operation region is also aligned in the column direction for the column having the positions 210p, 220p, and the like. Measurement is performed at this point in time for a rectangular region that surrounds the position 240p. The other syndrome qubits present in this column are also measured at this point in time.

FIG. 4b illustrates a situation for the point in time when the syndrome qubit 221 has moved to the position 210p. At this point in time, the counterpart for the CNOT operation is 223. The position 211p, which is vacant, is used to realize a CNOT between 221 and 223. There is a common-operation region in the column direction, as in the case of FIG. 4a. In addition, a CNOT operation or measurement is also performed for other regions surrounded by rectangles.

FIG. 4c illustrates a situation for a point in time when the syndrome qubit 221 has moved to the position 220p, and the position 226p that has become vacant is used to perform a CNOT operation with 224. FIG. 4d illustrates a situation for a point in time when the syndrome qubit 221 has moved to the position 230p, and the position 231p that has become vacant is used to perform a CNOT operation with 225.

FIG. 4e illustrates a situation for a point in time when the syndrome qubit 221 has moved to the end. Measurement is performed when the syndrome qubit 221 has reached 240p (FIG. 4e). There are also common-operation regions in the column direction in FIG. 4c through FIG. 4e, as in the case of FIG. 4a or FIG. 4b. In addition, a different CNOT operation or measurement is performed in a different column.

As in the case in FIG. 1, syndrome qubits are classified into two types. There are syndrome qubits that are surrounded by diagonal-line edges as with 221 in FIG. 3 and syndrome qubits that are surrounded by white-on-black edges as with 251 in FIG. 3. The former is responsible for bit-flip error detection, and the latter is responsible for phase-flip error detection. The role in CNOTs regarding control or target is converse between syndrome qubits responsible for bit-flip error detection and those responsible for phase-flip error detection. In addition, measurement is performed with Z-basis for syndrome qubits responsible for bit-flip error detection and with X-basis for syndrome qubits responsible for phase-flip error detection.

When a two-dimensional qubit array according to the present embodiment is caused to operate on the basis of a predetermined clock, for example, the qubit 221 and the qubit 222 move as follows.

Clock1: Qubit 221 moves to the position 200p (refer to FIG. 4a)
Clock2: Qubit 222 is caused to move to the position 201p
Clock3: Qubits 221 and 222 are caused to interact
Clock 4: Qubit 221 moves to the next vacant dot
Clock5: Qubit 222 moves to the next vacant dot
Needless to say, the above is an example, and a qubit may be caused to move in such a manner as to return in the reverse direction, if necessary.

In a highly integrated qubit array, the wiring is shared in units of rows and units of columns, and individual operations become difficult. In contrast, operations in units of rows or units of columns become advantageous. Locations with the same operation in each column are present in FIG. 4a through FIG. 4e. For example, attention is given to the position 200p in FIG. 4a. Assume that, for the purpose of a CNOT operation between the data qubit 222 and the syndrome qubit 221, 222 is moved to position 201p. A similar operation is also performed within enclosed regions that include the positions 301p, 311p, and 321p. These common-operation regions align in the column direction, but CNOT operations are not performed except for the enclosed regions that include the positions 200p, 301p, 311p, and 321p.

If a CNOT operation is performed by simultaneous control pertaining to a column in the enclosed regions that include the positions 200p, 301p, 311p, and 321p, it is necessary to cause qubits present at positions other than 200p, 301p, 311p, and 321p in the 200p column to evacuate from the 200p column.

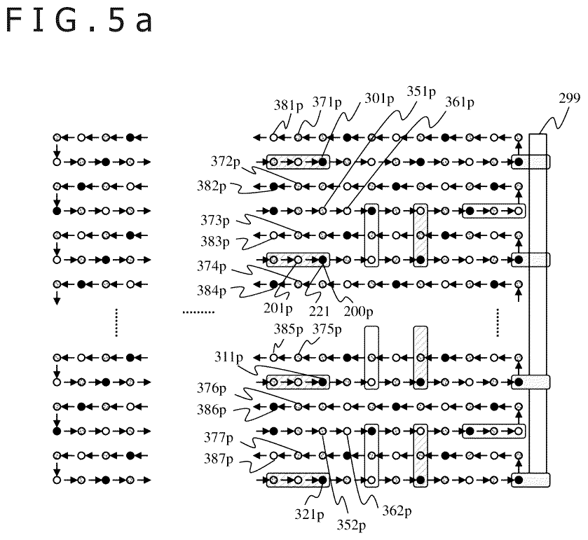

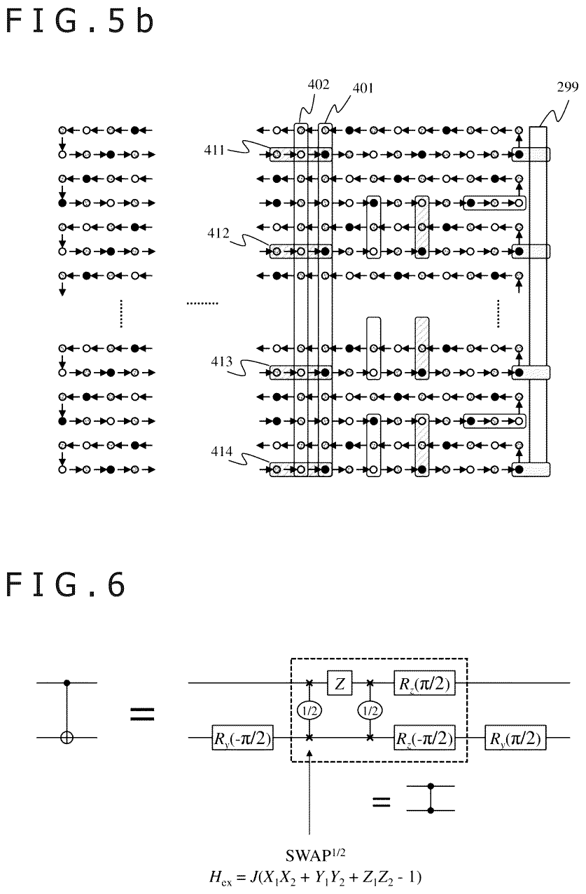

FIG. 5a illustrates a situation after qubits have been evacuated. The data qubits that have originally been at positions 351p and 352p are moved to 361p and 362p, respectively. Similarly in relation to the 201p column, it is necessary to cause qubits that are not involved in a CNOT operation to move. In FIG. 5a, the qubits that have originally been at 371p to 377p are caused to move to 381p to 387p. As a result, columns having 200p and 201p become vacant except for rows performing a CNOT operation.

FIG. 5b results from reorganizing FIG. 5a from the above perspective. In columns 401 and 402, qubits are only present in the rows for 411, 412, 413, and 414. As a result, simultaneous control for a CNOT operation in relation to the column direction is possible.

FIG. 5b illustrates simultaneous control pertaining to the column direction, taking the case of FIG. 4a as an example. Simultaneous control similarly becomes possible in the cases of FIG. 4b through FIG. 4e by causing qubits to move left and right or up and down.

In a case where a measurement unit is only present at a right end as in FIG. 3 through FIG. 5b, measurement is only performed when the syndrome qubits have come to the right end. Let the period of cycling of qubits be n times a syndrome measurement period. In this case, it is necessary for the error rate to be 1/n in comparison to the ordinary case of a surface code.

As described above, in the present embodiment, qubits are arranged at every other quantum dot, and a quantum dot in which a qubit is absent (a vacant dot) is present between quantum dots in each of which a qubit is present. A vacant dot becomes a temporary destination for the movement in causing a qubit to cycle (FIG. 4a through FIG. 4e) and, at the same time, becomes an evacuation site for a qubit for which there is no desire to perform an operation (FIG. 5a and FIG. 5b). Moving a qubit is performed by reducing the potential between quantum dots. Hence, there will be interaction if there is a qubit at a quantum dot that is the temporary destination for the movement. Accordingly, vacant dots are necessary in order to cause qubits to move or cycle.

The method of cycling qubits in the above-described embodiment causes qubits to cycle counterclockwise in units of two rows such that the qubits go toward the measurement unit, but cycling may be performed clockwise in units of two rows. In addition, alternating between clockwise and counterclockwise in units of two rows is also possible. At least, configuration may be taken such that a location at which measurement is possible is present in a portion of a cycling route.

### Second Embodiment

As illustrated in FIG. 2, a CNOT forms the foundation of syndrome measurement. However, a two-qubit operation in an actual device is not necessarily a CNOT.

An exchange interaction forms the foundation with semiconductor qubits for which high integration is expected. A Hamiltonian for exchange interaction between qubits i and j is provided as Hₑₓ=J(XᵢXⱼ+YᵢYⱼ+ZᵢZⱼ−1). X, Y, and Z represent Pauli spin matrices, and J represents the strength of the exchange interaction. If time passes with the exchange interaction between the qubits i and j, a state i and the state j swap (SWAP). If the exchange interaction is performed during exactly half the amount of time required for SWAP, a SWAP^{1/2} operation is performed.

FIG. 6 is a circuit diagram that illustrates a CNOT and an equivalent circuit thereof. A CNOT can be realized by a combination of two SWAP^{1/2}'s and single-qubit gates, and a circuit in this case is illustrated in FIG. 6. R_{y}(θ) and R_{z}(θ) represent a y-axis rotation and a z-axis rotation by an angle θ.

In FIG. 5b, qubits for performing a CNOT operation are arranged in the columns 401 and 402, and rows in which the CNOT operation is not performed are set to be vacant in the columns 401 and 402. A SWAP^{1/2} is a two-qubit operation, and thus the arrangement of FIG. 5a or FIG. 5b can be used. If the exchange interaction is set to off between the columns 401 and 402, this arrangement also may be used regarding the single qubit gate. Qubits within the column 401 and within the column 402 are all subjected to the same operation. Thus, simultaneous control of the columns becomes possible. Accordingly, even if the CNOT is decomposed into SWAP^{1/2}'s and single-qubit gates as in FIG. 6, the method described in the first embodiment is effective.

### Third Embodiment

Following the principle of quantum mechanics, if a state described as a |0>+b|1> is measured, it jumps to the state |0> at a probability of |a|² and to the state |1> at a probability of |b|². This is probabilistic, but the state is initialized to |0> or |1>. This is why no circuit for initialization is illustrated in FIG. 3 through FIG. 5b.

It is presupposed that initialization is performed through measurement. |0> is supposed to be the initial state in the error detection circuit in FIG. 2a. It is sufficient to consider that. When a measurement result is |1>, the roles of |0> and |1> are switched, and |1> is supposed to be the initial state. In the case of FIG. 2b, the measurement basis becomes |+> and |−>, but the principle is similar to that of the case of FIG. 2a.

In FIG. 3, the measurement unit that includes the measurement circuit 299 is only at the right end, but if a configuration is taken such that measurement is also possible at the left end, measurement becomes possible at double the efficiency.

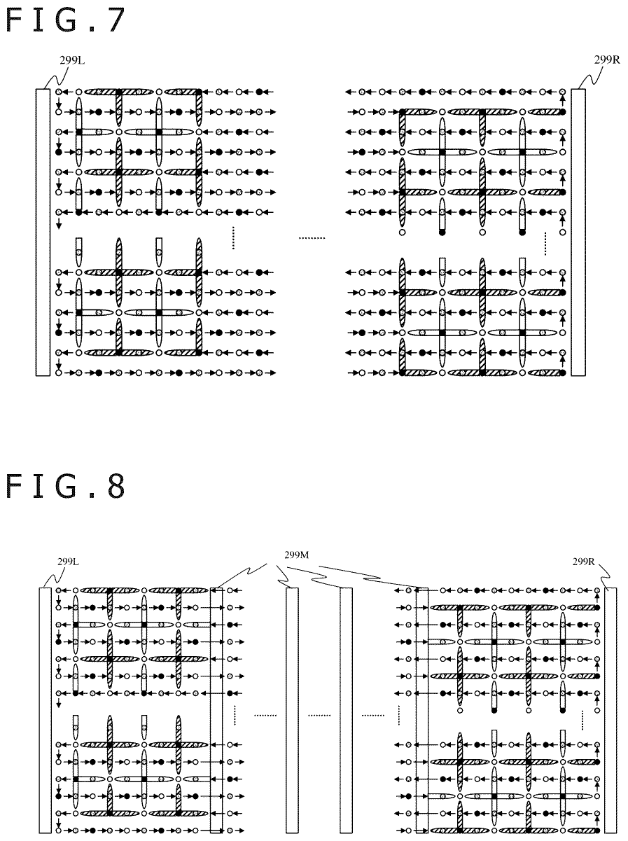

FIG. 7 is a conceptual diagram, for this case, of a third embodiment in which qubit measurement opportunities have been increased.

FIG. 8 is another conceptual diagram, for this case, of the third embodiment in which qubit measurement opportunities have been further increased. In FIG. 8, the measurement opportunities have been increased by providing measurement circuits 299M inside the array in addition to at the left and right ends. A measurement unit in which the measurement circuits 299 are arranged lacks quantum dots for arranging qubits, as is clear from FIG. 8. When causing a qubit to move through a measurement circuit 299 inside the array, the qubit is caused to move a longer distance in comparison to a case where quantum dots are adjacent. The area of each measurement circuit 299 is set as necessary.

A measurement circuit 299R on the right side in FIG. 7 measures syndrome qubits that have been cycled from the left, and a measurement circuit 299L on the left side measures syndrome qubits that have been cycled from the right. It is efficient if configuration is taken such that the measurement circuits 299M inside the array illustrated in FIG. 8 measure syndrome qubits that have been cycled from the left as well as syndrome qubits that have been cycled from the right. Furthermore, if a measurement unit is provided such that there is a match with the period of the stabilizer measurement illustrated in FIG. 2, stabilizer measurement without opportunity loss becomes possible.

In the case of FIG. 7 or FIG. 8, it is assumed that the period for measuring qubits is n times the syndrome measurement period. In this case, as in the case of the first embodiment, it is also necessary for the error rate to be 1/n in comparison to the ordinary case of a surface code.

### Fourth Embodiment

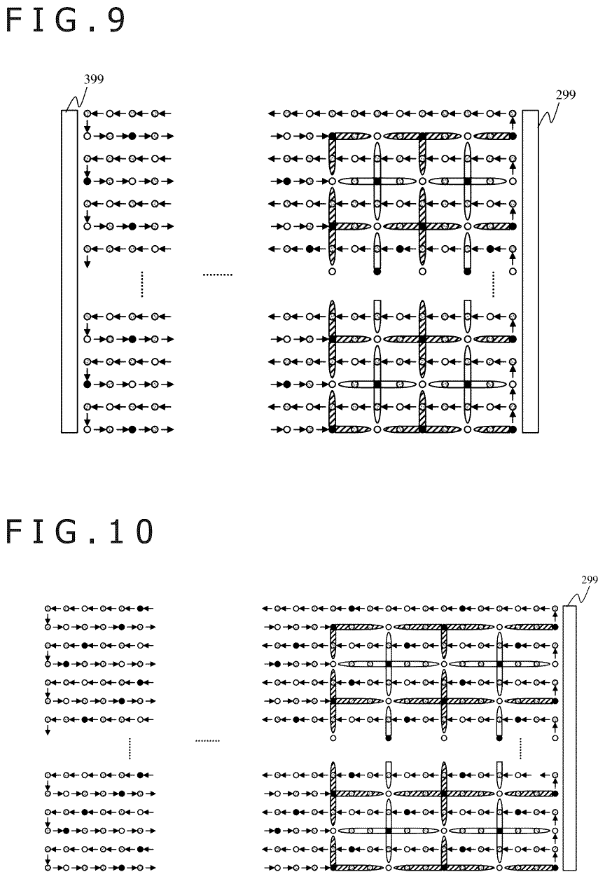

FIG. 9 is a conceptual diagram of a fourth embodiment that is premised on destructive measurement.

The third embodiment is premised on non-destructive measurement in which syndrome qubits remain after measurement, but there is also destructive measurement. In other words, there is a method of measuring by making a syndrome qubit be a component of the measurement circuit 299 when the syndrome qubit has come to the measurement unit. In a case of using electron spin as a qubit, this corresponds to supplying the electron to the measurement circuit 299. In this case, it is necessary to introduce initialized syndrome qubits to the array again. FIG. 9 illustrates this case.

A syndrome qubit that has reached the right end is taken in by the measurement circuit 299, and the position at which the syndrome qubit was present becomes vacant.

Accordingly, there is no black circle representing a syndrome qubit in flows from right to left. In the present embodiment, an initialization circuit 399 for injecting and initializing qubits into the quantum dot array is disposed at the left end, and syndrome qubits initialized by the initialization circuit 399 are introduced from the left end. Of course, there is no need to limit the position of the initialization circuit 399 to the left end.

### Fifth Embodiment

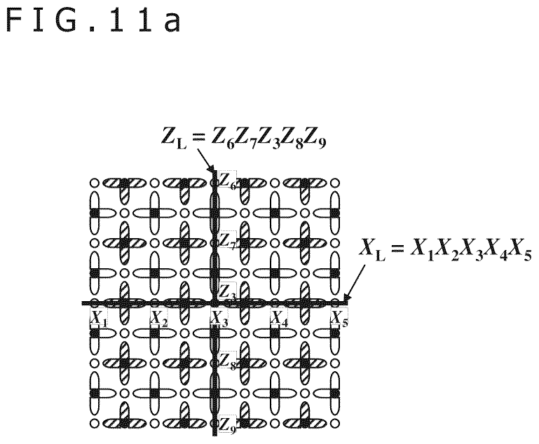

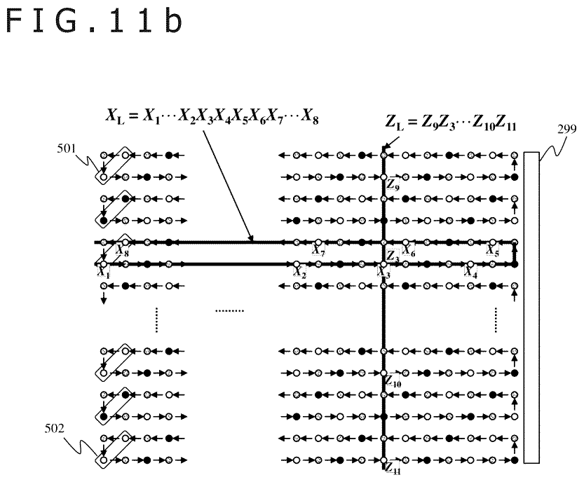

FIG. 10 is a conceptual diagram of a fifth embodiment in which the number of vacant quantum dots is increased. Positions at which qubits are present and vacant positions alternate in FIG. 3 through FIG. 9, but there are no changes to the operating principle even if there are even more vacant positions. For example, FIG. 10 illustrates a case where every third position has a qubit. The number of vacancies can be used as a qubit array design parameter.

### Sixth Embodiment

The first through fifth embodiments described perform stabilizer measurement while causing qubits to cycle. Except for causing qubits to cycle, the operating principle is the same as that of an ordinary surface code. Operation of a logical qubit is also similar to that of an ordinary surface code.

In FIG. 1, the total number of data qubits (white circles) is greater by one than the total number of syndrome qubits (black circles). The state of the data qubits is determined through stabilizer measurement, but the degree of freedom corresponding to one qubit remains without determined. This becomes the degree of freedom of a logical qubit.

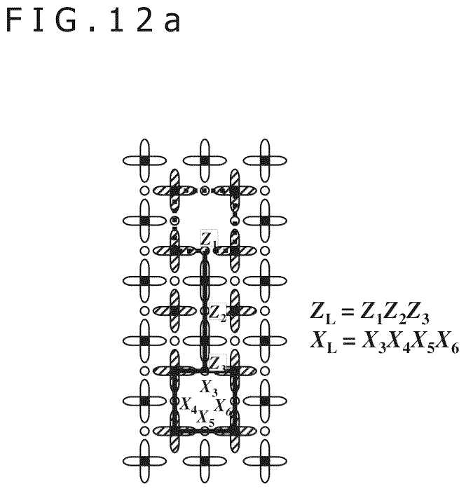

With the qubit arrangement in FIG. 1, a Z operator and an X operator for the logical qubit are defined as Z_{L}=Z₆Z₇Z₈Z₉ and X_{L}=X₁X₂X₃X₄X₅, as illustrated in FIG. 11a. The suffix L represents pertaining to the logical qubit.

Both operators are defined by the product of data qubits on lines joining ends. The X_{L} operator is configured by joining ends having white edges (edges that configure X stabilizers), and the Z_{L} operator is configured by joining ends having diagonal-line edges (edges that configure Z stabilizers).

In FIG. 11a, operators on the logical qubit are defined by joining ends. However, in a case where qubits are cycled, there ceases to be ends in the left-right direction. Accordingly, conceptual ends are made, and the logical qubit is defined (FIG. 11b).

FIG. 11b illustrates a Z_{L} operator and an X_{L} operator in a case where a surface code is implemented in a qubit array that is cycled, and attention is given to conceptual ends. In a surface code, white circles and black circles line up in an alternating manner. Similarly in FIG. 11b, if vacant locations are excluded, white circles and black circles line up in an alternating manner. An exception is made here. In FIG. 11b, enclosed portions at the left end have consecutive qubits of the same color if the vacant locations are excluded. This is the conceptual end. In particular, at portions 501 and 502, white circles, not black circles, are consecutive. This corresponds to the four corners in FIG. 11a being white circles. As a result, the number of white circles is one greater than the number of black circles, and it becomes possible to define a logical qubit. In FIG. 11b, the logical qubit is defined as Z_{L}=Z₉Z₃ . . . Z₁₀Z₁₁ and X_{L}=X₁ . . . X₂X₃X₄X₅X₆X₇ . . . X₈.

### Seventh Embodiment

In FIG. 11a and FIG. 11b, there was one more data qubit than syndrome qubits, and this became the degree of freedom of the logical qubit. Being able to create such a difference is owing to having four ends in FIGS. 11a and 11b (including conceptual ends), and assigning data qubits to the four corners. In order to increase the number of logical qubits, it is sufficient if the number of ends (boundaries) is increased.

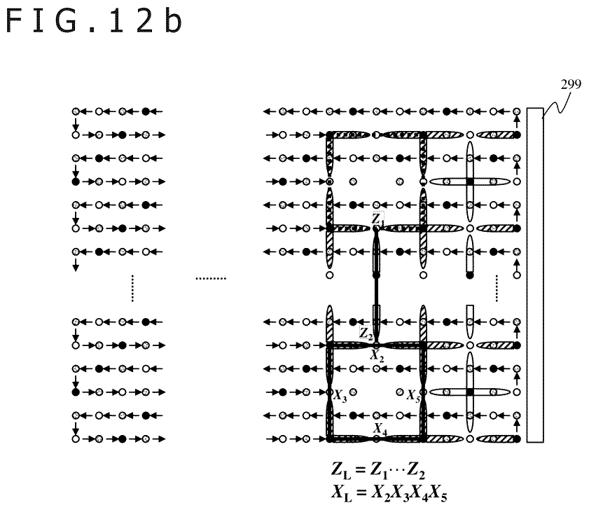

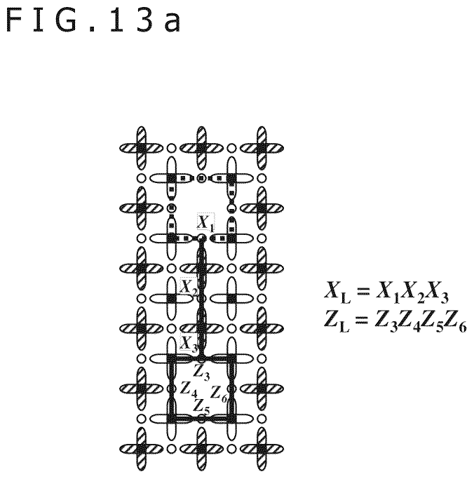

FIG. 12a illustrates an arrangement in which an artificial end has been produced. Syndrome qubits for X stabilizer measurement are removed from two locations to thereby achieve an artificial end. Being removed does not mean that qubits are not present, but that a CNOT operation and measurement pertaining to the syndrome qubits will not be performed. The locations where syndrome qubits have been removed can be said to be defects. The Z operator is defined by data qubits that join two defects, and becomes Z_{L}=Z₁Z₂Z₃. The X operator surrounds one defect and becomes X_{L}=X₃X₄X₅X₆. Logical qubits defined in this manner are referred to as defect-type qubits. As for FIG. 12a, X stabilizer measurements are stopped, and thus is an X-cut defect-type qubit.

FIG. 12b indicates that it is possible to similarly define a Z_{L} operator and an X_{L} operator by using an X-cut defect pair, even in a qubit array that is cycled. In FIG. 11b, locations where qubits of the same color are consecutive are necessary as with portions 501 and 502 in order to form a conceptual end, but locations where qubits of the same color are consecutive may be present or absent with the defect-type qubits in FIG. 12b.

Defect-type qubits also can be similarly defined by stopping Z stabilizer measurements (Z-cut defect-type qubits).

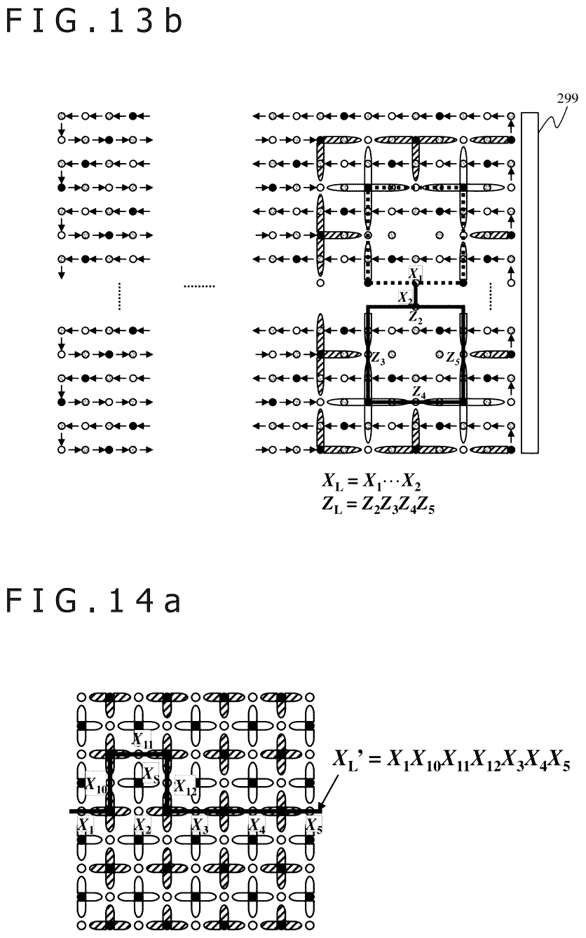

FIG. 13a is a conceptual diagram that illustrates a Z_{L} operator and an X_{L} operator that have been defined by using a Z-cut defect pair, and illustrates a case of stopping Z stabilizer measurement. The roles of the X operator and the Z operator are swapped in comparison to the case in FIG. 12a, and the X operator on the logical qubit is defined as X_{L}=X₁X₂X₃ by joining two defects, and the Z operator is defined as Z_{L}=Z₃Z₄Z₅Z₆ by enclosing one defect.

FIG. 13b indicates that it is possible to similarly define a Z_{L} operator and an X_{L} operator by using a Z-cut defect pair, even in a qubit array that is cycled.

### Eighth Embodiment

A logical qubit in a surface code is defined geometrically, and geometric deformation is possible.

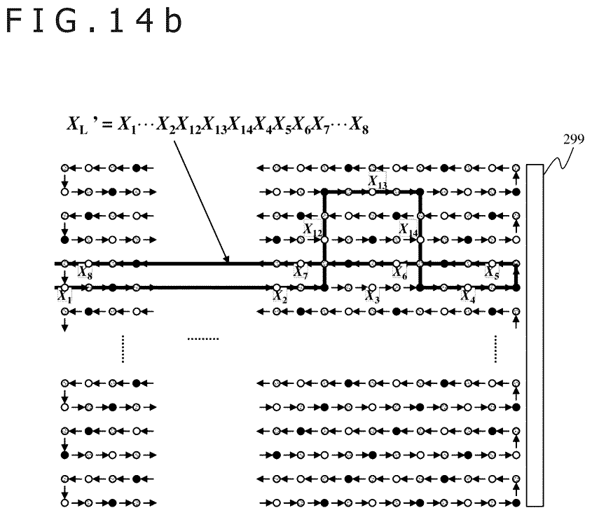

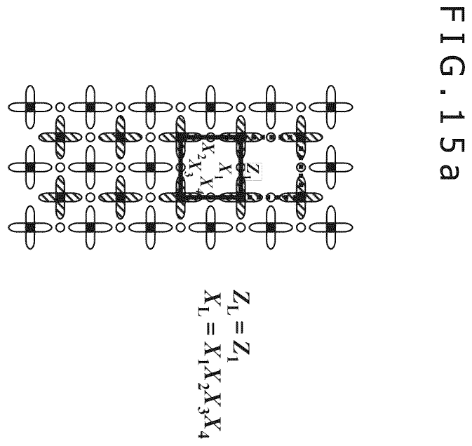

FIG. 14a is a conceptual diagram indicating that an X_{L} operator in a surface code can be geometrically deformed. For example, it may be that the X_{L}=X₁X₂X₃X₄X₅ in FIG. 11a is multiplied by a stabilizer X_{S}=X₂X₁₀X₁₁X₁₂ illustrated in FIG. 14a, and a newly obtained X_{L}′=X₁X_{S}=X₁X₁₀X₁₁X₁₂X₃X₄X₅ is employed as the X operator. If this deformation is repeated, the position of the logical qubit inside the qubit array can be freely changed.

FIG. 14b indicates that an X_{L} operator can be similarly geometrically deformed even in a qubit array that is cycled. In the case of FIG. 14b, a new X operator becomes X_{L}′=X₁ . . . X₂X₁₂X₁₃X₁₄X₄X₅X₆X₇ . . . X₈. Geometric deformation is possible in a similar fashion in regard to the Z operator as well.

Geometric deformation is possible in a similar fashion, even in regard to a defect-type logical operator. In addition, it is also possible to change the position of a defect. A case of changing the position of a defect means changing the location at which syndrome measurement is stopped (reference: Non-Patent Document 3).

### Ninth Embodiment

A CNOT operation is realized by repeating the geometric deformation illustrated in the eighth embodiment in a surface code, and braiding two defect-type logical qubits (reference: Non-Patent Document 3). Even in a case where qubits are cycled, a CNOT operation is possible if the geometric deformation is similarly repeated.

A Hadamard gate HL for a logical qubit is realized by a Hadamard gate on a data qubit included in a logical qubit and geometric deformation in the surface code (reference: Non-Patent Document 3). Even in a case where qubits are cycled, a Hadamard gate becomes possible with a similar process.

An S_{L}=(Z_{L})^{1/2} gate is realized by preparing |Y_{L}>=(|0_{L}>+i|1_{L}>)/√2 referred to as a magic state in an auxiliary qubit and performing Hadamard gates and CNOT operations between the magic state and the logical qubit state (reference: Non-Patent Document 3).

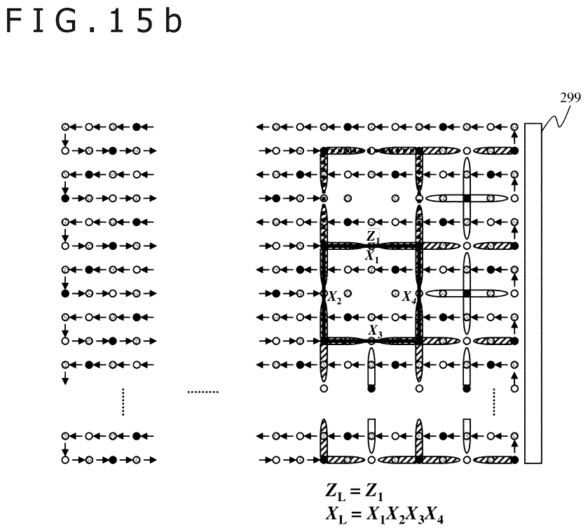

FIG. 15a illustrates a logical qubit where two defects in FIG. 12a are set adjacent. This is used to produce |Y_{L}>. In this case, Z_{L}=Z₁, and thus the Z_{L} operator is composed of an operation on merely one data qubit. Data qubit Z₁ is initialized to |+>, and the S=(Z)^{1/2} gate is merely performed to achieve |Y₁>. This is used to realize S_{L}.

FIG. 15b illustrates a logical qubit where two defects are set adjacent similarly, in a case where qubits are cycled. Based on this, |Y_{L}> is produced, and S_{L} is realized.

A T_{L}=(S_{L})^{1/2} gate is realized by preparing |A_{L}>=(|0_{L}>+e^{in/4}|1_{L}>)/√2 referred to as a magic state in an auxiliary qubit and then performing a CNOT operation between the auxiliary qubit and logical qubit, measuring the auxiliary qubit, and executing S_{L}, X_{L}, and Z_{L} on the logical qubit on the basis of the measurement result (reference: Non-Patent Document 3). A similar process can be executed even in a case where qubits are cycled.

The present embodiment has indicated that CNOT_{L}, T_{L}, and HL are possible. If these three are set up, universal quantum computations are possible.

### Tenth Embodiment

The present embodiment pertains to an error correcting code (abbreviated as a code) used in a quantum computer, and the operation method thereof is described by taking a surface code as an example. In the present embodiment, description is given regarding where an error correcting code is used when the entire system is viewed.

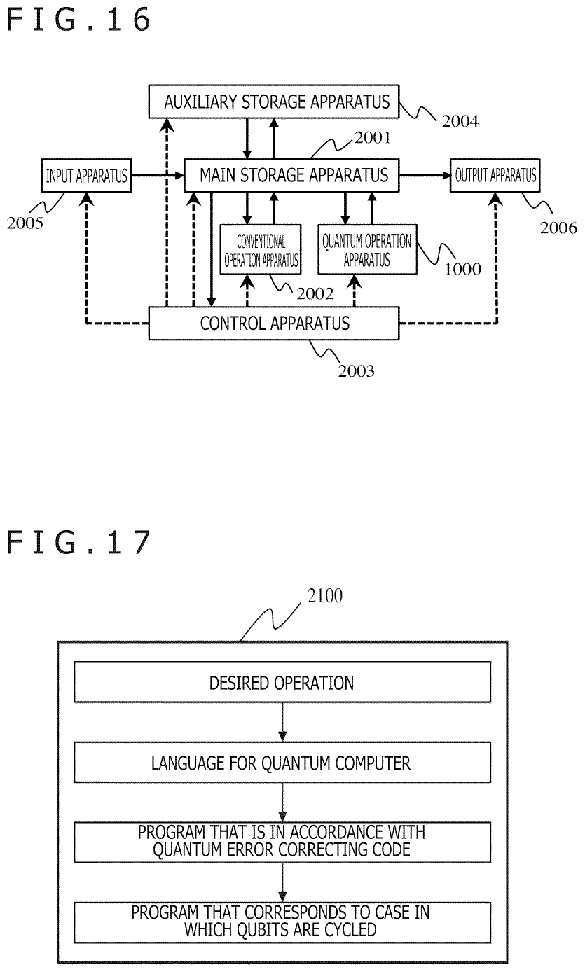

FIG. 16 illustrates an example of a configuration of a computer according to the present embodiment. FIG. 16 is similar to the configuration of an ordinary computer, but is characterized by including a quantum operation apparatus 1000. The quantum operation apparatus 1000 uses the quantum error correcting codes described in the first through ninth embodiments, to perform a quantum-mechanical operation in a specialized manner. Other conventional operations are performed with a conventional operation apparatus 2002.

The above configuration may be constructed as an integrated computer, or may be constructed with another computer to which any portion such as a main storage apparatus 2001, the conventional operation apparatus 2002, a control apparatus 2003, an auxiliary storage apparatus 2004, an input apparatus 2005, and an output apparatus 2006 are connected by a network.

A conventional operation is performed in accordance with a procedure that is similar to that for an ordinary computer. Data is exchanged between the main storage apparatus 2001, which is a storage unit, and the conventional operation apparatus 2002, which is an operation unit, and operation proceeds by the repetition thereof. In such circumstances, the control apparatus 2003 conducts overall commands. A program executed with the conventional operation apparatus 2002 is stored in the main storage apparatus 2001, which is a storage unit. In a case where the storage capacity in the main storage apparatus 2001 is insufficient, the auxiliary storage apparatus 2004, which is also a storage unit, is used. The input apparatus 2005 is used to input data, a program, or the like, and the output apparatus 2006 is used to output a result. The input apparatus 2005 includes a manual input apparatus such as a keyboard, and also an interface for network connection. In addition, this interface also serves as an output apparatus.

A quantum operation is performed in accordance with a similar procedure. Data is exchanged between the main storage apparatus 2001, which is a storage unit, and the quantum operation apparatus 1000, which is an operation unit, and the operation proceeds by the repetition thereof. In such circumstances, the control apparatus 2003 conducts overall commands. A program executed with the quantum operation apparatus 1000 is stored in the main storage apparatus 2001, which is a storage unit.

Using the conventional operation apparatus 2002, the program is converted to codes that are used with the quantum operation apparatus 1000, and stored in the main storage apparatus 2001. In a case where the storage capacity is insufficient, the auxiliary storage apparatus 2004, which is also a storage unit, is used. This encoded program is sent from the main storage apparatus 2001 to the quantum operation apparatus 1000, and the control apparatus 2003, in accordance with the encoded program, sends a control signal to the quantum operation apparatus 1000 to execute an operation. An execution result from the quantum operation apparatus 1000 is sent to the main storage apparatus 2001, and post-processing is performed with the conventional operation apparatus 2002 if necessary.

### Eleventh Embodiment

Computer operations are generally considered through dividing into hardware and software. In the tenth embodiment, a configuration has been described from a hardware perspective. In the present embodiment, a configuration is described from a software perspective.

FIG. 17 is a flow chart that illustrates an example of software for realizing the present embodiment. In order to cause the quantum operation apparatus 1000 to operate by a method of the present embodiment in which qubits are cycled, a desired operation is translated into a language pertaining to a quantum computer, this is translated into a program that has been subjected to an error correcting code (surface code), and this is also translated into a case in which qubits are cycled. A result of packaging this series of translation tools becomes software 2100 (FIG. 17) for the present embodiment.

The software 2100 is saved in the auxiliary storage apparatus 2004 by using the input apparatus 2005. Translation based on the software 2100 is performed with the conventional operation apparatus 2002 under the control with the control apparatus 2003. A program translated for the present embodiment is saved in the main storage apparatus 2001 and sent to the quantum operation apparatus 1000 on the basis of the control with the control apparatus 2003, and an operation is executed. A program that does not fit within the capacity of the main storage apparatus 2001 is saved in the auxiliary storage apparatus 2004, and is sent to the main storage apparatus 2001 in accordance with the control with the control apparatus 2003 when necessary.

Description has been given above for a method of causing a surface code to operate on a qubit array that is cycled. The reason why operations similar to those for an ordinary surface code are possible despite the cycling is because the positional relation between the qubits illustrated in FIG. 3 is preserved even if there is cycling. In other words, if viewed from a coordinate system that is cycling, the qubits look like stopping except for the movement to a vacant quantum dot.

In the above-described embodiments, description has been given regarding operation in an error detection process to which attention has been given in embodiments. An original intentional operation that should be performed may be performed in an interval between a series of error detection processes, or simultaneously therewith. For example, if a Z_{L} gate is “an original intentional operation that should be performed,” a Z gate is applied to each qubit of Z_{L}=Z₉Z₃ . . . Z₁₀Z₁₁ in the case of FIG. 11b. Because cycling or measurement is performed in a chain reaction manner, there is a period of time in which there is no operation on Z_{L}=Z₉Z₃ . . . Z₁₀Z₁₁. Then, if the Z_{L} gate is applied in the meantime, the operation can be concurrent with the error detection process. In a case where adjustment is complicated, a flow for the error detection process may be stopped temporarily, and the operation may be performed in the meantime.

As described above, in the present embodiment, even in an array having limited measurement locations, by causing qubits to cycle within the array, syndrome qubits periodically appear at measurement locations, and measurement becomes possible. Accordingly, periodically measuring syndrome qubits becomes possible, and implementation of quantum error correction becomes possible without impairing the advantages of high integration in a highly integrated qubit array.

In addition, a vacant quantum dot is provided between a data qubit and a syndrome qubit, whereby qubits can move inside the array, and interaction between any adjacent data qubits and syndrome qubits becomes possible. As a result, syndrome measurement periodically becomes possible even in an array in which measurement locations are limited, and implementation of quantum error correction becomes possible even in a highly integrated qubit array.

In addition, the same operation aligns in the column direction or the row direction, and an intended operation becomes possible even with shared wiring. At this point, a qubit that is intended to stay away from the effect of the operation is evacuated to a vacant quantum dot.

By virtue of the present embodiment, realization of a practical quantum computer becomes possible, and it is also possible to expect a reduction of an amount of carbon dioxide emissions and to use for the preservation of the environment.

### DESCRIPTION OF REFERENCE SYMBOLS

101: Syndrome qubit for bit-flip error detection
102: Syndrome qubit that is for bit-flip error detection and is positioned at an end
103: Syndrome qubit for phase-flip error detection
111, 112, 113, 114: Data qubits adjacent to the syndrome qubit 101
200p, 201p, 210p, 211p, 220p, 226p, 230p, 231p, 240p: Position of quantum dots for arranging qubits
221: Syndrome qubit for bit-flip error detection
222, 223, 224, 225: Data qubits adjacent to the syndrome qubit 221
251: Syndrome qubit for phase-flip error detection
301p, 311p, 321p: Positions of quantum dots for arranging qubits
351p, 352p, 361p, 362p: Positions of quantum dots for arranging qubits
371p through 377p: Positions of quantum dots for arranging qubits
381p through 387p: Positions of quantum dots for arranging qubits
401, 402: Certain columns
411, 412, 413, 414: Enclosure for indicating qubit pair for which an interaction is desired
1000: Quantum operation apparatus
2001: Main storage apparatus
2002: Conventional operation apparatus
2003: Control apparatus
2004: Auxiliary storage apparatus
2005: Input apparatus
2006: Output apparatus
2100: Software

1. A quantum computer comprising:
a quantum operation unit, wherein
the quantum operation unit includes a quantum dot array for arranging qubits, a gate unit for performing a gate operation on the qubits, and a measurement unit for measuring the qubits,
the qubits are classified into data qubits for holding information and syndrome qubits for performing measurement, the data qubits and the syndrome qubits are arranged in the quantum dot array in an alternating manner, and a vacant quantum dot is arranged between the data qubit and the syndrome qubit in the arrangement, and
the qubits arranged in the quantum dot array are caused to cycle in a row direction or a column direction of the quantum dot array, and measurement is performed when the syndrome qubit has reached a location inside the quantum dot array at which measurement by the measurement unit is possible.

2. The quantum computer according to claim 1, wherein, before measurement of the syndrome qubits, the data qubits and the syndrome qubits are caused to interact at the gate unit, and information of the data qubits is transferred to the syndrome qubits.

3. The quantum computer according to claim 2, wherein the interaction is performed between the data qubit and the syndrome qubit that are adjacent.

4. The quantum computer according to claim 1, wherein, in order to perform a gate operation at the gate unit, the vacant quantum dots are used to move at least one of the data qubit and the syndrome qubit to cause the two qubits to be adjacent.

5. The quantum computer according to claim 1, wherein an error in the data qubits is detected by measuring the syndrome qubits.

6. The quantum computer according to claim 1, wherein a plurality of regions in which at least one of the gate operation and measurement of the qubits is performed in common are present in a column direction or a row direction of the quantum dot array, and the common operation/measurement is executed simultaneously in the plurality of regions.

7. The quantum computer according to claim 1, wherein a location at which measurement by the measurement unit is possible is arranged at one or a plurality of ends of the quantum dot array.

8. The quantum computer according to claim 7, wherein the locations at which measurement by the measurement unit is possible are also arranged inside the quantum dot array.

9. The quantum computer according to claim 1, comprising:
a location for injecting a qubit into the quantum dot array.

10. The quantum computer according to claim 1, wherein a plurality of the vacant quantum dots are present between the data qubit and the syndrome qubit.

11. The quantum computer according to claim 1, wherein the data qubit and the syndrome qubit are, in principle, alternately arranged in the quantum dot array where the vacant quantum dot is placed between them, but, as an exception, locations at which the data qubits and the syndrome qubits are each consecutively arranged while placing the vacant quantum dot between them are arranged.

12. The quantum computer according to claim 11, wherein, a conceptual end is defined as a location at which the data qubits and the syndrome qubits are consecutively arranged while placing the vacant quantum dot between them, and an X operator and a Z operator for a logical qubit are defined as a product of data qubits present between two ends of the quantum dot array or a product of data qubits present between the conceptual ends.

13. The quantum computer according to claim 1, wherein the syndrome qubit for which the measurement and the gate operation are not performed exists, the syndrome qubit for which the measurement and the gate operation are not performed is defined as a defect, two defects are deemed to be an end, and a product of the data qubits present between the two defects and a product of the data qubits that surround one defect are used to define an X operator and a Z operator for a logical qubit.

14. The quantum computer according to claim 1, comprising:
a storage apparatus, a conventional operation apparatus, a control apparatus, an input apparatus, an output apparatus, and a quantum operation apparatus, wherein
operation by the quantum operation unit that is included in the quantum operation apparatus is controlled by the control apparatus.

15. The quantum computer according to claim 14, wherein,
in the storage apparatus, software for quantum computing that is performed in the quantum operation apparatus is stored, and
the conventional operation apparatus executes the software to translate a desired operation into a language pertaining to the quantum computer, translate the language into a program that has been subjected to error correcting coding, further convert the program to a case where qubits are cycled, and save a result of performing the conversions in the storage apparatus.
